(19) United States
(12) Patent Application Publication
(10) Pub. No.: US 2013/0017519 A1
(43) Pub. Date: Jan. 17, 2013

(54) SYSTEM AND METHODS FOR MONITORING AND ADJUSTING HUMAN BEHAVIORAL PATTERNS AND CONDITIONS

(71) Applicants: Gilly Leshed, Ithaca, NY (US); Justin Cheng, Singapore (SG); Akshay Bapat, Foster City, CA (US); Gregory Thomas, New York, NY (US); Kevin Tse, New York, NY (US); Nikhil Nawathe, Mumbai (IN); Jeremy Crockett, Miami, FL (US)

(72) Inventors: Gilly Leshed, Ithaca, NY (US); Justin Cheng, Singapore (SG); Akshay Bapat, Foster City, CA (US); Gregory Thomas, New York, NY (US); Kevin Tse, New York, NY (US); Nikhil Nawathe, Mumbai (IN); Jeremy Crockett, Miami, FL (US)

(21) Appl. No.: 13/528,564

(22) Filed: Jun. 20, 2012

Related U.S. Application Data
(60) Provisional application No. 61/498,987, filed on Jun. 20, 2011.

(51) Int. Cl. G09B 19/00

(52) U.S. Cl. 434/238

(57) ABSTRACT

A system and methods for delivering “behavioral modification content” to a user. Behavioral modification content includes any information that can be perceived by the user, including perceived visually, aurally, tangibly, or aromatically by the user for the purpose of reminding the user to temporarily remove himself or herself from the context in the person is operating and attempt to better understand that context. Embodiments of the present invention also permit the user to create and save reflections about the behavioral modification content.

This application claims the benefit of U.S. Provisional Application No. 61/498,987 filed Jun. 20, 2011, which is incorporated by reference in its entirety.

### BACKGROUND

Many technologies are known that utilize devices by which users can establish and maintain contact and through such contact “socially network”. LinkedIn, Facebook, Hashable, and Foursquare are just some of such social networks. An interesting paradox has developed through the use of such systems. Some users “tend to” or “nurture” the devices, and the online systems running on them to the exclusion of everyday life. Such users can become disconnected from society and the real world. Users can miss or fail to recognize the cues that others employ to guide social contact, personal behavior, and interactions.

Even if a person has not become alienated from society by online “social networking”, the pace of daily life, work, and other technological tools may cause some people to overlook the context in which they operate and the person's own behavior and mental and physical health. Many devices exist that allow people to remain accessible even when not at home or work. The expectation largely exists that a person should be accessible regardless of the location and time. This may lead to an increase in stress and a decrease in self-awareness and self-improvement. People find they have less and less opportunity, even for a small amount of time, to simply disconnect from the networks and review the context in which they are operating and their own mental and physical health.

Known devices and procedures for reminding people to assess their behavior and record their thoughts have certain limitations such as lack of portability, complicated interfaces, or inability to manage and track data such as to identify trends.

A demand therefore exists for a system and methods that encourages a user to mentally remove himself or herself for a certain period of time from the context in which the person normally operates and thereby provide the person with the opportunity to reflect on that context, even assess the person's mental and physical condition, and take steps to identify and possibly decrease stress based on calculated trends. The present invention satisfies this demand.

### SUMMARY OF THE INVENTION

Certain embodiments of the present invention will be discussed with reference to delivery of certain information—behavioral modification content—, but this discussion is merely exemplary. Embodiments of the present invention may deliver any type of information to a user.

The present invention includes a system and methods that permit storage of and/or receiving Behavioral Modification Content (also “BMC”) for the purpose of delivering the BMC to a user. Certain BMC is configured to encourage the user to practice healthier habits, prepare journal entries such as reflections, and decrease stress. Such BMC often result in the user experiencing physical health benefits such as healthier blood pressure such as increasing or decreasing blood pressure, healthier heart rate such as increasing or decreasing heart rate, decreased emission of stress hormones, reduction of lactic acid build-up in muscle tissue, balancing levels of oxygen and carbon dioxide in the blood, weight loss or weight gain, normalized brain function, and improved immune system function such as strengthening T-lymphocyte cells.

Additional BMC is designed to cause the user to temporarily disconnect from the context in which the user is operating so that the person can evaluate that context and make immediate changes or at least consider making longer-term adjustments in personal behavior. The present invention may facilitate therapeutic expression of thoughts, feelings, and ideas, assessing and improving the user's personal mental and physical health, improving memory and concentration, reconnecting with the “real world”, interacting with people such as through face-to-face conversations, recognizing and appreciating the social cues that people deliver in such interactions to guide the course of such interactions, and making adjustments in behavior.

For purposes of this invention, the term “Behavioral Modification Content” includes any information that can be perceived by a user, including that perceived visually, aurally, tangibly, or aromatically by the user for the purpose of causing the user to temporarily remove himself or herself from the context in the person is operating and have the opportunity to better understand that context (that is, to be able to “reflect” on that context). Such information also may be another form of stimulus that is intended to achieve the same objective.

In certain embodiments, BMC may include a photograph which the user has not seen before or a photograph that the user has seen before. BMC may include text such as, but not limited to, a thought-provoking message, passage from another person's work, or be something prepared by the user for a given occasion. BMC may include a moving image such as video clip of an occurrence in which the user was involved, an event in which the user was not involved, a staged event such as a movie, television show, animation, or commercial. BMC may include a drawing, painting, or other artwork prepared by another or the user. BMC may include music or words from a third party source or prepared by the user. BMC may include sounds such as the sound of nature (wind, waves, flowing water, birds chirping, etc.) or other sounds from manmade objects such as non-musical sounds (engines running, planes flying, etc.). BMC may include combinations of the above.

Certain embodiments of the present invention permit content providers to create BMC for use in the system. Content providers may create BMC having commercial information, advertisements, motivational information, health information, or other information.

In certain embodiments, some BMC may be categorized or related to a specific theme. Various themes for BMC may include breathing, relaxing, slowing down, reflecting, sleeping, organizing, preparing for events, maintaining healthy habits, eating better, reduction in smoking, managing prescription drug or over-the-counter drug intake, exercising, meditations, managing emotions, communicating, empathizing, smiling, laughing, personal hygiene, hobbies, motivations, values, ethics, brain stimulation, and any other theme that promotes health or improved wellness.

For purposes of this application, a “user” of the system is anyone who is permitted to access at least some portion of the system. In certain embodiments, the user may access the system through a system interface such as a user interface component.

Embodiments of the present invention may include a filtering component by which a user selects which BMC it wishes to receive. A filtering component may include an analysis sub-component configured to analyze the qualities and characteristics of BMC in order to associate the BMC with a theme. An analysis sub-component also may analyze the user-specific information and the qualities of the BMC to determine when certain BMC items should be delivered.

Certain embodiments of the filtering component permit a selector—that is, someone other than the user such as a caretaker, family member, or healthcare provider—to select the BMC that the user will receive. In certain embodiments, a user or selector may have found, created, or loaded certain BMC into a memory component for use in the system. In other embodiments, a content provider may have created or loaded BMC into a memory component. A user may designate whether he or she wishes to have the BMC delivered to himself or herself or if the uploaded BMC is available to be delivered to other users.

Using the filtering component, a user may select how (e.g., through a notification pop-up, an email, auditory emission, or signal sent to a peripheral device) and when he or she wishes to receive the BMC. A user also may individually designate each BMC unit or one or more pre-determined categories of BMC that he or she wishes to receive.

In certain embodiments, the user may designate any of a number of selection criteria for selecting the BMC that he or she wishes to receive. One type of selection criteria is termed “random selection”. In such embodiments, BMC are selected randomly from a large database of content for delivery to the user at random times. In other embodiments, the BMC is selected randomly, but the delivery time or time range may be determined by the user. In certain embodiments, a random unit or stream of BMC is sent, for example, every day at a certain time, hourly, twice a day, or daily to encourage the user to “slow down” ultimately to permit the user to avoid or manage stress and eliminate or reduce the physical manifestations of stress. Receipt of such suggestions may encourage serendipity and spontaneity in that every day the user may be surprised by the BMC that is delivered. The user may be inspired and develop new ways to moderate behavior, “slow down”, and manage the stress.

Certain embodiments of the filtering component permit the user to select at least some subset (e.g., all the BMC associated with a specific theme, or multiple BMC items selected individually by the user) from a larger possible set of BMC that the user selects to receive as a surprise. Certain embodiments allow the user to select a time frame when the surprise content will be delivered. The time frame may include designations such as during the user's waking hours, during break time at work, or when the user knows that he or she may not be sleeping, driving, or operating machinery.

Another embodiment of the filtering component permits the user to designate “context-specific” BMC selection criteria. In such embodiments, the BMC is selected for delivery based on criteria specifically tailored to the anticipated or current contextual state of the user based on user-specific information received by the system. When the filtering component, or an analysis sub-component of the filtering component, receives information about certain increased-risk circumstances, the BMC is delivered before, at the time of, or after the increased-risk circumstances. In such embodiments, the BMC units may be preventative or responsive to the increased-risk circumstances. For purposes of this application, increased-risk circumstances may include, for example, a busy schedule, an increased heart rate, increased blood pressure, too little sleep, a bad mood, a user reflection that includes words that indicate anger, anxiety, or stress, or a location in which the user experienced a stressful situation in the past.

Such embodiments may utilize a device such as a user-specific information component that can collect or at least receive information about the surroundings of the user or the contextual state of the user. The user-specific information may include entries from the user's calendar, user information such as user mood, user feelings, or personal sensor information. Personal sensor information may include, but are not limited to, information received from sensors that measure time that the person has rested or slept, heart rate, galvanic skin response (detecting arousal/calmness), environmental sensors—including those that determine the temperature in which the person is operating, humidity, wind conditions, solar or other radiation—and the current location of the user from a global positioning system or other location-detection sensors. Such personal sensors may be configured to send and receive information collected about the user. Personal sensor information may be manipulated to generate a personal information display, which may include a chart, graph, image, or other display of personal information.

Certain embodiments of the present invention permit the user to designate random delivery of BMC, context-specific delivery of BMC, or both random delivery and context-specific delivery of BMC. The embodiment that permits a user to choose both context-specific BMC and random BMC at different times supports both customized utility and random spontaneity.

The BMC may be stored in a memory component in the device that the user utilizes to receive the content. The BMC may also be retrieved from other memory components, libraries, and databases including periodically and as needed. The BMC may include the user's own personal photos of family members, familiar places, peaceful scenes, etc.) or clips of movies, television programs, radio programs, music, or sounds.

Certain embodiment may include messaging components by which information may be sent to and received from a selector, caretaker, family member, or other person to permit that person to monitor the user's condition and possibly select BMC for the user given the user's condition.

Certain embodiments of a method include installation of a system in conjunction with a computer system and completing setup tasks such as creating a user identification code and designating filtering component information. For example, when the user first opens the system, a settings prompt may appear asking whether the user wants to modify any settings in the settings module. The settings prompt may include an overview of the system and filtering component options such as changing the time, type of BMC, or method of BMC delivery. In certain embodiments, the user interface component will provide proposed BMC delivery options such as a morning suggestion and an evening reflection. Specifically, the morning suggestion may default to a certain time such as 10 am, and an evening reflection may default to a certain time such as 10 pm. The user may change any of the filtering component options presented. The user then can navigate to any other part of the application.

Certain embodiments of the user interface component includes a series of displays. A display may include a module viewer and a tab bar. The module viewer may be configured to permit viewing of any module in the system, including a suggestion module, a reflection module, a diary module, a settings module, or other modules. The tab bar may include navigation elements having a symbol corresponding to each module or a sub-module. When the user selects that symbol, the selected module or sub-module is displayed in the module viewer portion of the display. While the module is displayed, the corresponding navigation element may include a different color than the remaining navigation elements or otherwise may have some difference to permit the user to identify which module is on display.

The “home” page, or display that populates the module viewer upon opening the system may be the suggestion module display. A system module display may include, for example, a name of a theme, a BMC unit such as a “suggestion”, or an information icon. In certain embodiments, the theme name includes a semi-transparent portion that is overlaid on a photograph or other BMC. The information icon may be positioned near the top right side of the display, the top left side of the display, bottom right side of the display or the bottom left side of the display, or another position in the display. An information icon indicates to the user that more information is available. The user may access the additional information by tapping on any part of the module viewer, which may cause a change in the display such that the additional information related to that which was previously displayed is revealed.

In certain embodiments, a new suggestion is revealed every time the suggestion module is opened or refreshed. Certain embodiments permit a user to retrieve past-viewed suggestions, while other embodiments do not permit a user to retrieve past-viewed suggestions.

In certain embodiments, certain action or inaction by the user will stop the delivery of suggestions or other BMC. For example, if a user does not create a reflection during a certain time period such as an hour after receiving a suggestion or within a certain calendar day, delivery of additional suggestions and other BMC are stopped. In such embodiments, delivery of suggestions and other BMC may resume upon the user creating a reflection. In certain embodiments, if the user opens a suggestion module or a reflection module and does not close it, a new suggestion will not be provided until the system is re-opened, even if other triggers for a new BMC have occurred. In certain embodiments, a notification will be displayed that informs the user that new suggestions will not be displayed until the user takes a certain action such as creating a reflection or closing and re-opening the system.

In certain embodiments, a user entering a new time zone will trigger the display of a new suggestion. In other embodiments, the time zone change will not trigger a new suggestion.

After viewing a suggestion, a user may dismiss the suggestion by ignoring it or activating a “Dismiss” option, or selecting an “Open” option to open the suggestion module. If the suggestion module opens, the user may view additional information about the suggestion and may include a “theme” option. A “theme” option may include a beveled rectangle and may reveal a more detailed suggestion content.

Upon accessing the reflection module, a sub-module menu may appears in the module viewer. The user may select Add color sub-module option, Add text sub-module option, or Add photograph sub-module option.

In the Add color sub-module, the user may be presented with an option to select the color of the day from a color selector having multiple colors. The user may select a “Save” option to save the color reflection to an internal memory component, an external memory component, or a server. The user may select the “Done” option to return to the main Reflect module.

In the Add text sub-module, the user may be presented with a textbox in which to type reflections based on letters and characters. The user may select a “Save” option to save the text reflection to an internal memory component, an external memory component, or a server. The user may select the “Done” option to return to the main Reflect module.

In the Add photo sub-module, the user may be presented with a viewfinder to take a photo. The user may select a “Take Photo” option when the viewfinder displays that which the user wishes to photograph. The user may select a “Save” option to save the photograph reflection to an internal memory component, an external memory component, or a server. In embodiments in which the methods are implemented on a computer system, the photograph may be saved in the system internal memory component and the computer system's main memory. The user may select the “Done” option to return to the main reflection module.

In certain embodiments, if the user does not activate the “Save” option, the reflection will be saved automatically upon closing the reflection module.

A user may create multiple reflections per day. Certain reflections may be associated with certain suggestions. For example, if a suggestion includes a statement like “How was your day?”, “We suggest you reflect on your day”, or another suggestion that calls for a response, the responding reflection will be associated with the suggestion to provide context. Other reflections may be created independently and will not be associated with any suggestion.

In certain embodiments, a reflection may be sent outside of the system, for example, to another user of the system through the messaging component, to a third party at an email address, or to a social networking account. In such embodiments, the user may request that the reflection is sent outside the system or the reflection may be sent automatically.

Upon entering the diary module, a user may view previously saved reflections one at a time possibly by the date on which the reflections were saved. In certain embodiments, the user cannot edit previously saved reflections after the reflection entry is closed. In other embodiments, the user can open and edit previously saved and previously closed reflections.

In certain embodiments, the diary module may crop reflections or reduce reflection size to produce a diary sub-module menu options. The menu options may be arranged as a list or a visualization. In certain embodiments of the diary module, each reflection or each day is represented by a visualization instead of a list. The visualization may include, for example, a flower whose type, species, or color is set by the color chosen by the user through the reflection module. If more than one color is chosen, more flowers appear in the diary module. If more than three colors are chosen, a bouquet of flowers is shown or each color is displayed on a petal of each flower. In certain embodiments, if a user checks the Diary screen without creating a new reflection, a full-screen image of a blank field with no flowers may be displayed. Certain reflections may be configured to be viewed in various sizes and shapes.

In certain embodiments of a diary module, if a user checks the Diary

Module without reflecting, an image of the words “no reflections” may be displayed in the diary module. Also, if a user has no reflections on certain days, these days may be absent from the diary module.

Certain embodiments of the settings module permit the user to disable delivery of the BMC. Other embodiments provide obstacles to disabling delivery of the BMC.

It is one object of embodiments of the present invention to permit a user to improve quality of life by delivering randomly selected BMC to the user.

Another object of embodiments of the present invention is to permit a user to improve quality of life by delivering filtered BMC to the user.

Another object of embodiments of the present invention is to permit a user to improve quality of life by delivering filtered context-specific BMC to the user.

Another object of embodiments of the present invention is to permit a user to create BMC.

Another object of embodiments of the present invention is to permit a user to add BMC that the user created or the user found into the system.

Another object of embodiments of the present invention is to facilitate changes in habits or behaviors by delivering reminders of the steps necessary to achieve those changes.

Another object of embodiments of the present invention is to facilitate expression of feelings, thoughts, or ideas through creation of reflections.

Another object of embodiments of the present invention is to permit the user to reflect on the events of his or her day.

Another object of embodiments of the present invention is to facilitate tracking of a user's feelings, thoughts, or ideas through creating visualizations.

Another object of embodiments of the present invention is to improve the user's health by, for example, decreasing blood pressure, decreasing heart rate, decreasing emission of stress hormones, reducing lactic acid build-up in muscle tissue, balancing levels of oxygen and carbon dioxide in the blood, weight loss, normalizing brain function, and improving immune system function such as by strengthening T-lymphocyte cells.

Another object of embodiments of the present invention is to provide a simplified display that includes a module viewer and tab bar.

Another object of embodiments of the present invention is to provide a module viewer configured to permit viewing of a suggestion module, reflection module, and a settings module.

Another object of embodiments of the present invention is to permit a user to perceive a representation including an audible representation and a visual representation of user information such as information provided in reflections.

Another object of embodiments of the present invention is to permit a user to perceive a personal information display including an audible representation and a visual representation of personal sensor information such as information provided by personal sensors.

Another object of embodiments of the present invention is to avoid interfering into the life or day-to-day functioning of the user by implementing an unobtrusive system.

Another object of embodiments of the present invention is to permit the user to select frequency of use of the system and methods.

Another object of embodiments of the present invention is to permit the user to review and reflect on previously saved reflections.

Another object of embodiments of the present invention is to permit easy use of the system and methods.

Another object of embodiments of the present invention is to reduce the ease with which the user may disable or turn off the BMC delivery to promote continuous use of the system and methods.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The patent or application file contains at least one drawing executed in color. Copies of this patent or patent application publication with color drawings will be provided by the Office upon request and payment of the necessary fee.

The preferred embodiments of the invention will be described in conjunction with the appended drawings provided to illustrate and not to the limit the invention, where like designations denote like elements, and in which:

FIG. 1A-FIG. 1D illustrate certain embodiments of the present invention;

FIG. 2 illustrates certain embodiments of a memory component;

FIG. 3A-FIG. 3C illustrate certain embodiments of filtering components;

FIG. 4 illustrates an embodiment of an output component and a user interface component;

FIG. 5 illustrates an embodiment of a user interface component;

FIG. 6A-FIG. 6G illustrate certain embodiments of a suggestion module of a user interface component;

FIG. 7A-FIG. 7G illustrate certain embodiments of a reflection module of a user interface component;

FIG. 8A-FIG. 8G illustrate certain embodiments of a diary module;

FIG. 9A-FIG. 9B illustrate certain embodiments of a settings module;

FIG. 10A illustrates an embodiment of a system having an internal server;

FIG. 10B illustrates an embodiment of a system having multiple users and an external server;

FIG. 10C illustrates an exemplary schematic of an embodiment of a server;

FIG. 10D illustrates an exemplary system class diagram for certain embodiments;

FIG. 11 illustrates an embodiment of the system in relationship to a computer operating system;

FIG. 12 illustrates an exemplary diagram of a dependency chart of certain embodiments of the present invention;

FIG. 13 illustrates an exemplary computer system that may be used to implement certain embodiments of the present invention; and

FIG. 14 illustrates an embodiment of a method according to the present invention.

### DETAILED DESCRIPTION OF EMBODIMENTS OF THE INVENTION

Certain embodiments of the present invention may include a system and method which permit a user to receive BMC at various times. Certain embodiments also permit the user to manage, distribute, play, display, record, and store BMC.

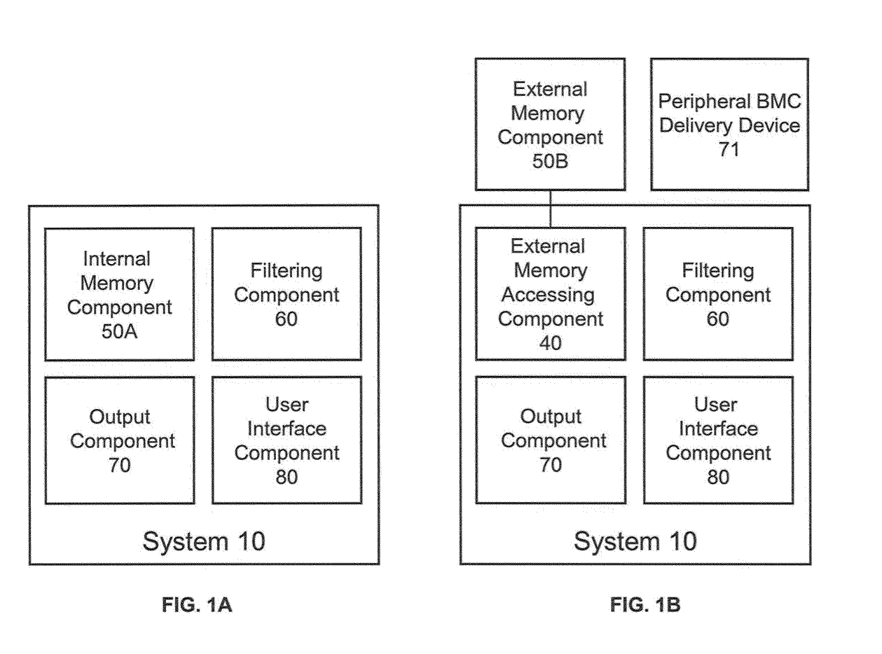

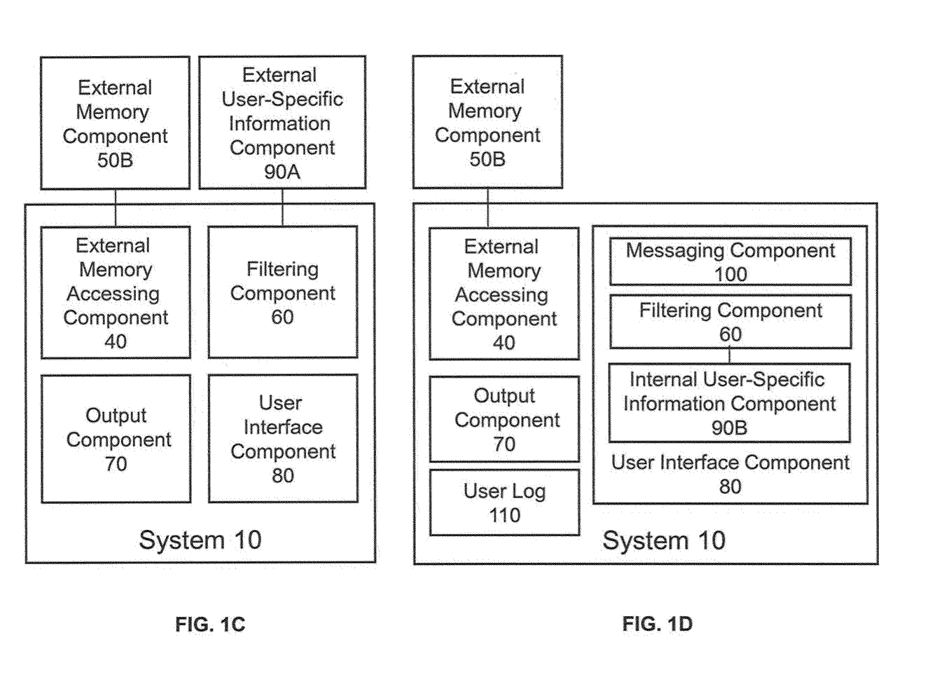

Certain embodiments of a system 10 include an internal memory component 50A configured to store BMC, a filtering component 60, an output component 70, and a user interface component 80, as illustrated in FIG. 1A. Other embodiments of a system 10 may be configured to store the BMC external from the system 10. Such embodiments may include an external memory accessing component 40, a filtering component 60, an output component 70, and a user interface component 80, as illustrated in FIG. 1B. Certain embodiments may include an external memory accessing component 40 and an internal memory component 50A such that the embodiment may store BMC and receive BMC from outside sources.

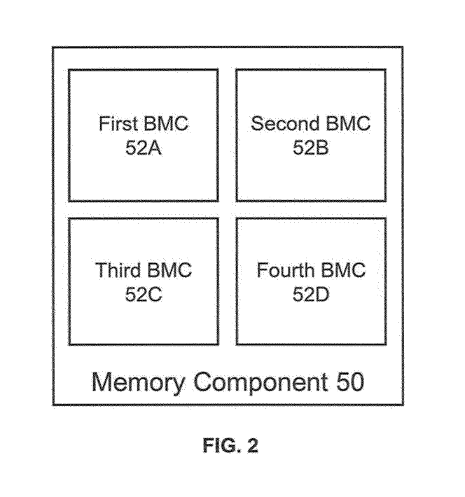

As illustrated in FIG. 2, a memory component 50 is configured to store at least BMC. In certain embodiments, a memory component 50 may store BMC, user reflections, user diary entries, and user settings. A memory component 50 may store any number of BMC including, for example, a first BMC 52A, a second BMC 52B, a third BMC 52C, and a fourth BMC 52D. Embodiments of a memory component may include random access memory (“RAM”), read-only memory (“ROM”), mass storage device, a hard disk unit, a removable storage unit, a floppy disk, ZIP disks, magnetic tape, portable flash drive, optical disk such as a CD or DVD, Blu-ray, Micro-Electro-Mechanical Systems (“MEMS”), nanotechnological apparatus, or any combination.

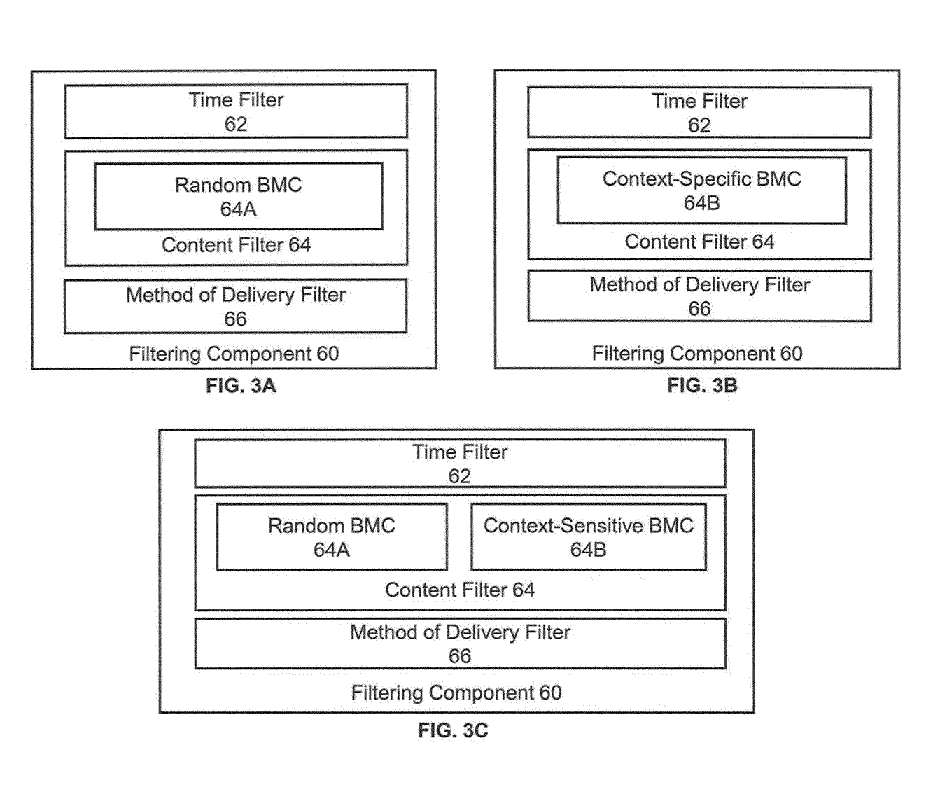

As illustrated in FIG. 3A-FIG. 3C, a filtering component 60 is configured to permit the user to designate when, how, and which BMC is delivered to the user. Embodiments of the filtering component 60 may include filters, including, but not limited to, a time filter 62, a content filter 64, and a method of delivery filter 66.

A time filter 62 may permit the user to designate a specific one time delivery (e.g., 8:00 a.m. on Mon., Jun. 18), a specific time with repeated delivery (e.g., every day at 8:00 a.m., every Tuesday at 8:00 p.m., or the 10th day of every month at 12 p.m.), a specific time range with one time delivery (e.g., 8:00 a.m.-11:00 a.m on February 1), a specific time range with repeated delivery (e.g., every day between 2 p.m.-5 p.m., every Saturday from 7 a.m.-12 p.m., or the 15^{th} of every month between 10 p.m and 1 a.m.), a context-specific time delivery based on input from a user-specific input component 90, or random time of delivery in which the time of delivery is randomly generated. A user may select more than one time filter such that the user may receive more than one message in a time period (e.g., twice a day, three times a day, four days a week, etc.).

Certain embodiments of the content filter 64 may permit the user to designate which type of BMC is delivered. In certain embodiments, the content filter permits selection of random BMC 64A, context-specific BMC 64B, or a combination of both 64C. Certain embodiments of the system 10 include a user-specific input component 90 that permits generation and transfer of information specific to the user for the purpose of identifying relevant context-specific BMC 64B.

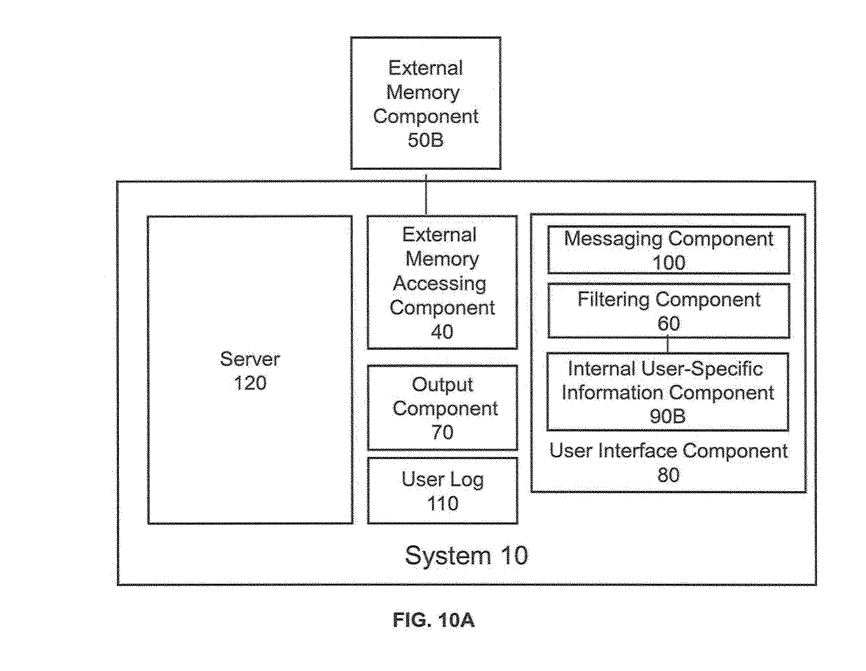

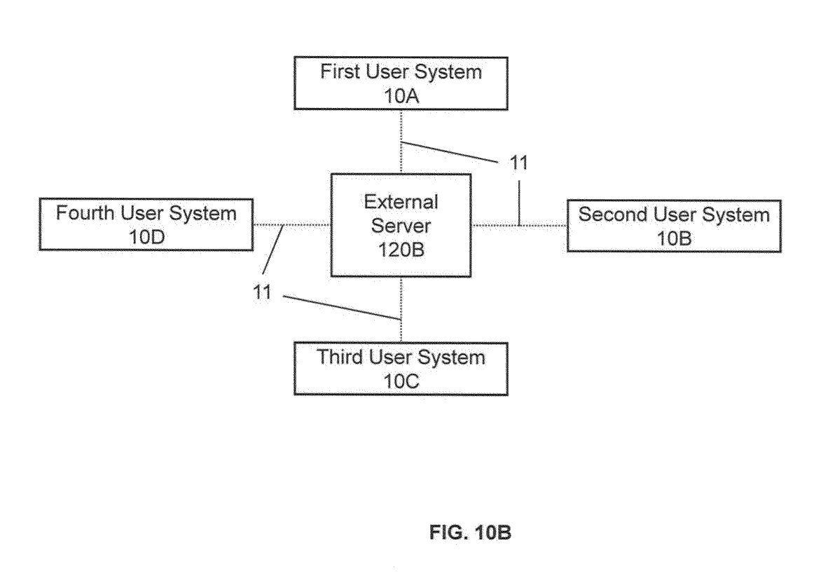

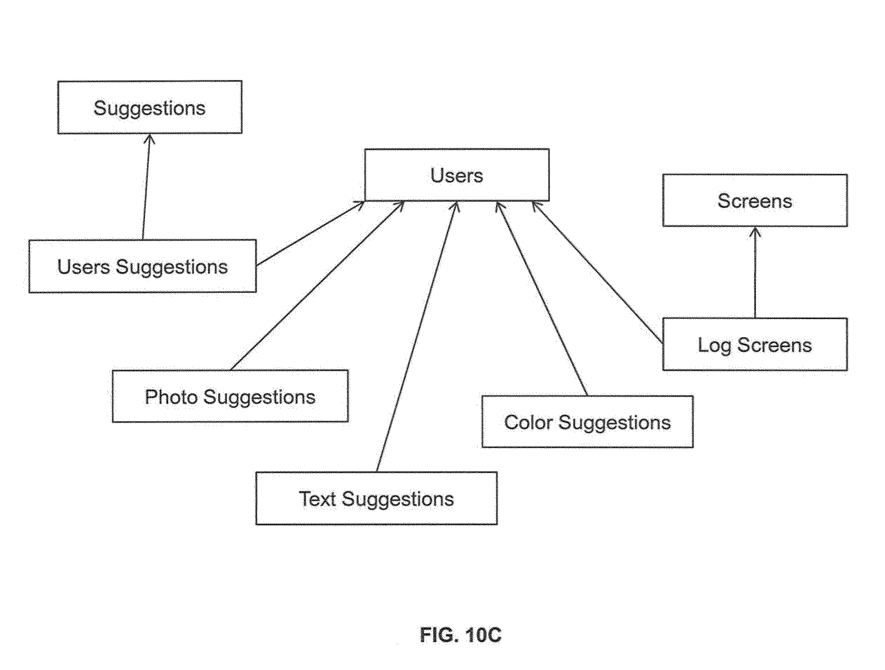

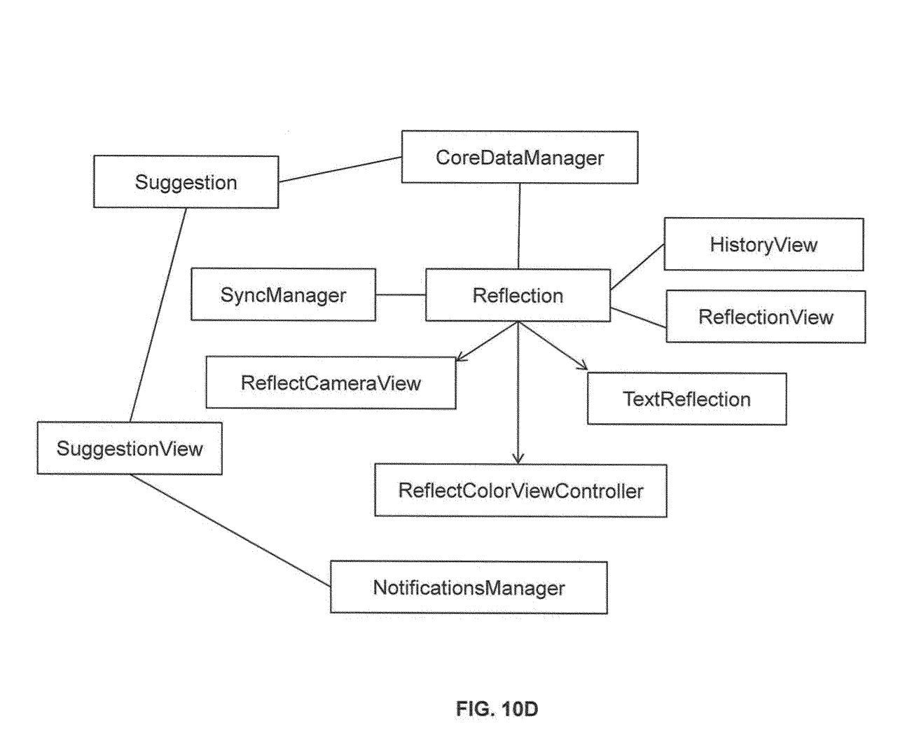

Certain embodiments of a user-specific input component 90 may include an external user-specific information component 90A, as illustrated in FIG. 10, or an internal user-specific information component 90B, as illustrated in FIG. 1D. A user-specific information component 90 may include a user's calendar, user information such as user mood, user feelings, information generated by a third person about the user (e.g., a healthcare professional, caretaker, or a family member), or personal sensor information. A personal sensor may include, but is not limited to, sensors that measure time that the person has rested or slept, heart rate, galvanic skin response (detecting arousal/calmness), environmental sensors—including those that determine the temperature in which the person is operating, humidity, wind conditions, solar or other radiation—and the current location of the user from a global positioning system or other location-detection sensors. A content filter 64 also may permit the delivery of multiple BMC units having a certain theme.

A method of delivery filter 66 may permit the user to designate how it wishes to receive the BMC. In certain embodiments, the user may designate auditory delivery of the BMC, visual delivery of the BMC through an email message, a message sent through the messaging component, a pop-up notification, or a signal sent to a peripheral device 71 to deliver the BMC. Embodiments of a peripheral device 71 may include a computer system 1300, a display component such as a screen, a touchscreen, a television, or a monitor, a sound emitter such as a speaker, a series of buttons that change position, a fragrance emitter, or anything that permits the user to view, hear, touch, smell, or otherwise receive a BMC.

An output component may be configured to permit the user to interact with the user interface component 80. An output component 70 may include a display component such as a screen, a touchscreen, a television, or a monitor, a sound emitter such as a speaker. An output component 70 also may include a device having components that changes in shape or potion for tactile perception, a vibration component, a fragrance emitter, or anything that permits the user to view, hear, touch, smell, or otherwise interact with the user interface component 80.

In certain embodiments, a user interface component 80 may permit the user to provide designations to the filtering component 60, enter information into an internal user-specific information component 90B, and send and receive messages through the messaging component. Certain embodiments of a user interface component 80 include one or more modules 82 that can be viewed by the user through the output component 70 such as a display frame component 70A and a touchscreen component 70B.

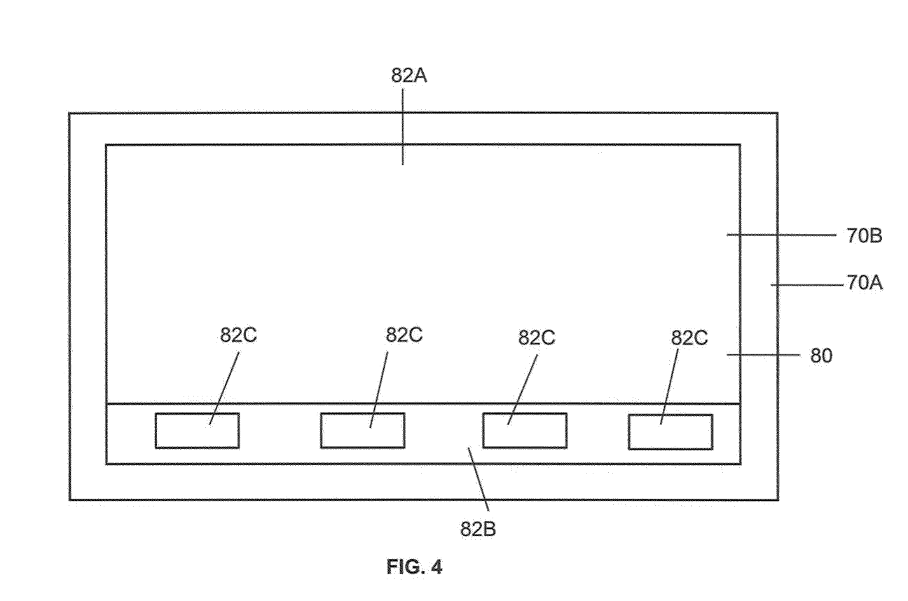

As illustrated in FIG. 4, the modules 82 may be viewed in a module viewer 82A and may be selected for viewing from a tab bar 82B. A tab bar 82B may include navigation elements 82C that display a button or symbol for each module or a sub-module. When the user is in a certain module, the corresponding navigation element may be illuminated.

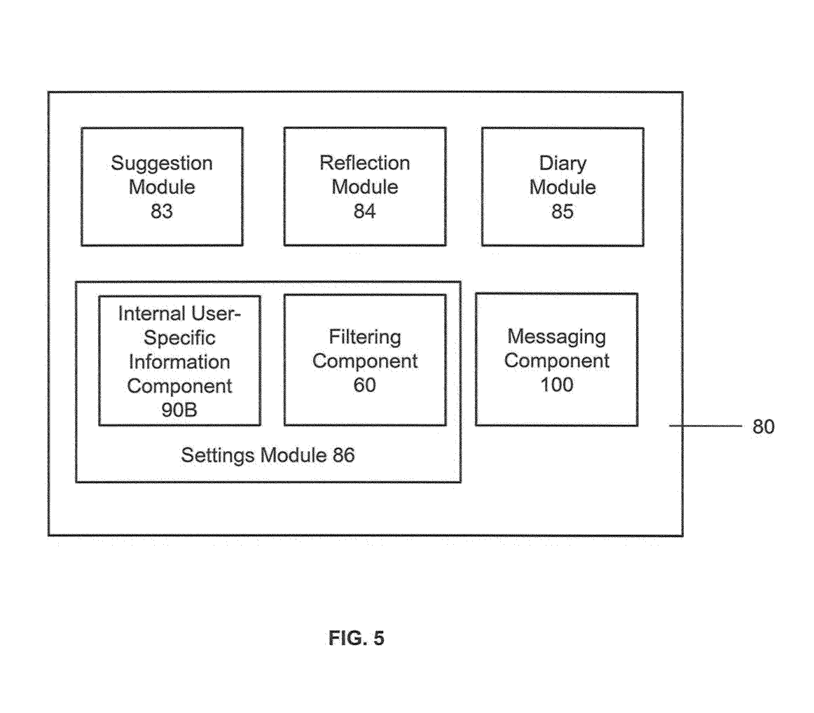

As illustrated in FIG. 5, modules 82 may include a suggestion module 83, a reflection module 84, a diary module 85, and a settings module 86.

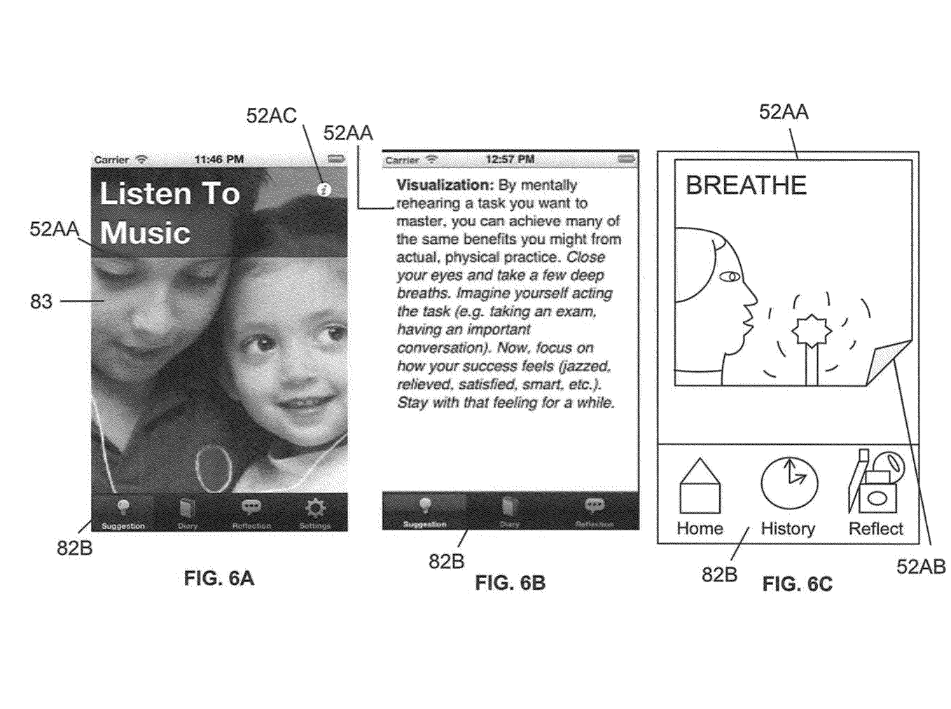

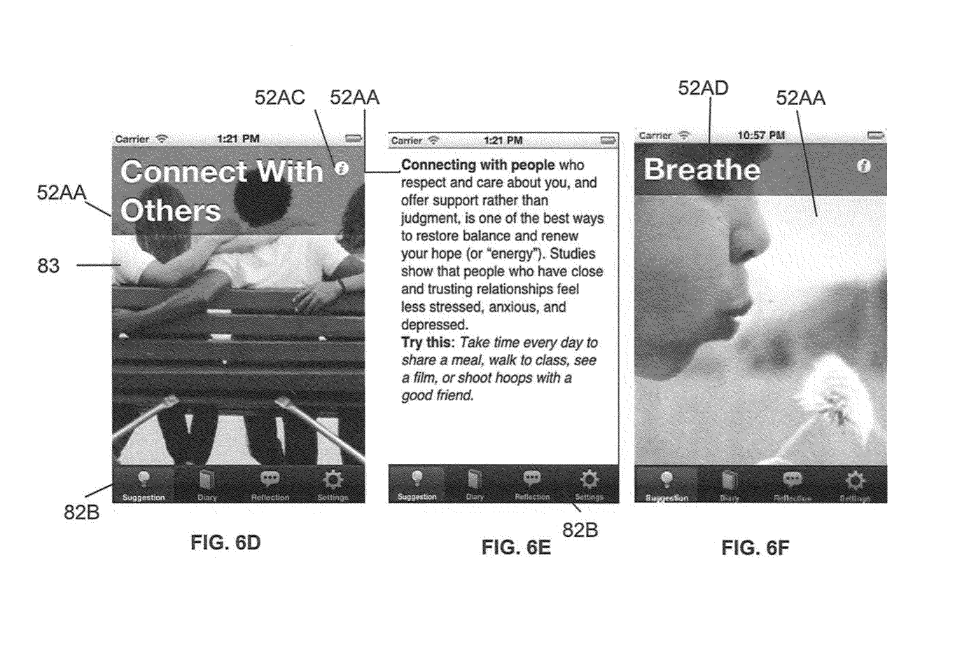

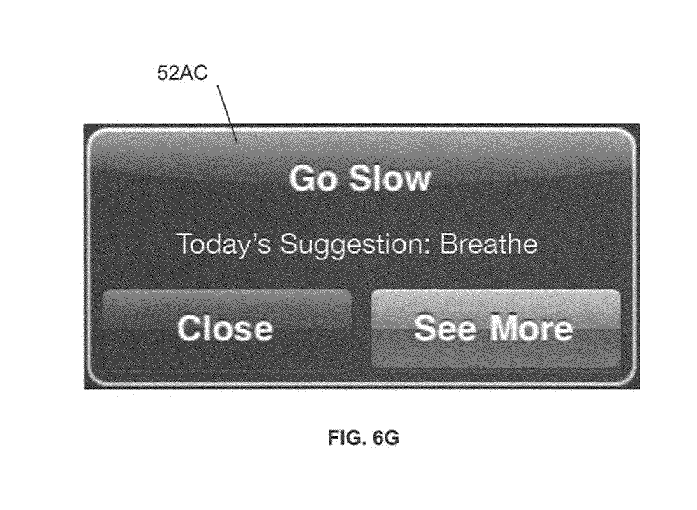

In certain embodiments, the suggestion module 82B may be configured to permit the user to view the BMC 52 as a “suggestion” 52AA, as illustrated in FIG. 6A-FIG. 6G. Certain embodiments of a suggestion 52AA may include multiple pages and accordingly, include a page turning button 52AB. A suggestion 52AA also may include display of an information icon 52AC, by which the user may obtain additional information. A “theme name” 52AD also may appear and may include a partially transparent section such that the suggestion content is partially visible. Embodiments of a suggestion 52AA may include a notification 52AE, as illustrated in FIG. 6G.

A suggestion 52AA may be associated with the day in the user's time zone, and under certain circumstances, suggestions may change daily. A suggestion 52AA may be displayed when, for example, either the user first opens the application that day or the user receives a “morning” notification, whichever is first. In certain embodiments, when a user designates “random” BMC selection, the following rules are applied to select the BMC suggestion 52AA. If a suggestion has not been displayed before, display it. All suggestions not viewed in the last 14 days have an equal chance of appearing on a certain day. Suggestions seen within the last 14 days will not be displayed.

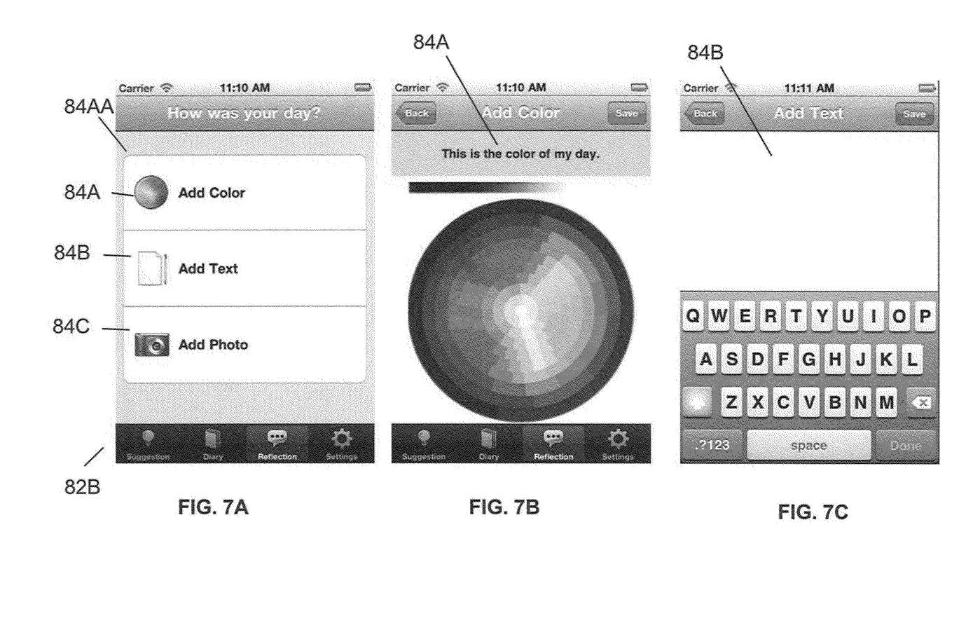

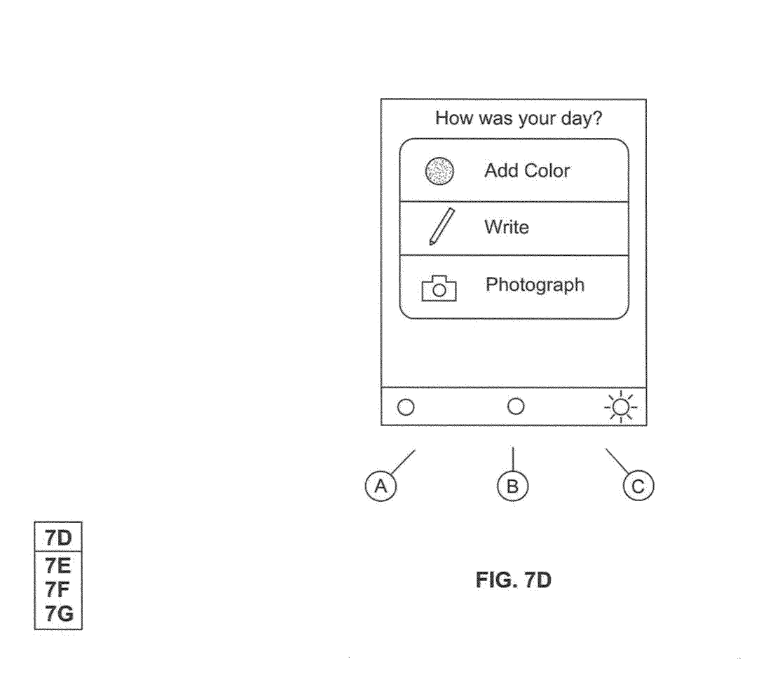

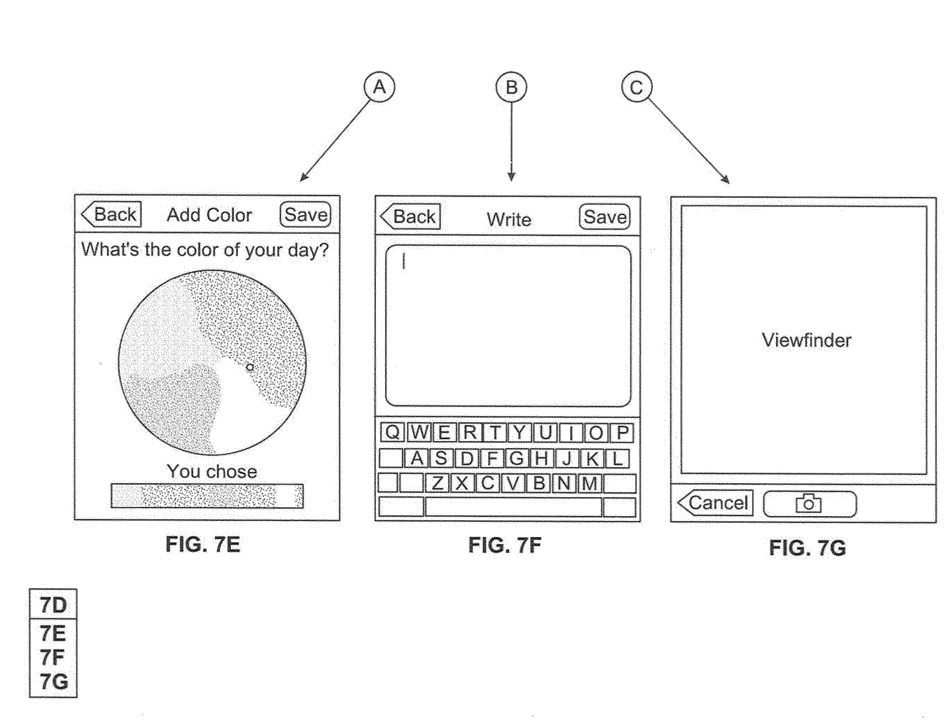

Certain embodiments of the reflection module 82C may be configured to permit the user to create reflections about the suggestions, about life, or about thoughts. Certain embodiments of a reflection module 84 include a sub-module menu 84AA including sub-modules such as an “add color” sub-module 84A, an “add text” sub-module 84B, and an “add photo” sub-module 84C. Multiple embodiments of a reflection module are illustrated in FIG. 7A-FIG. 7G.

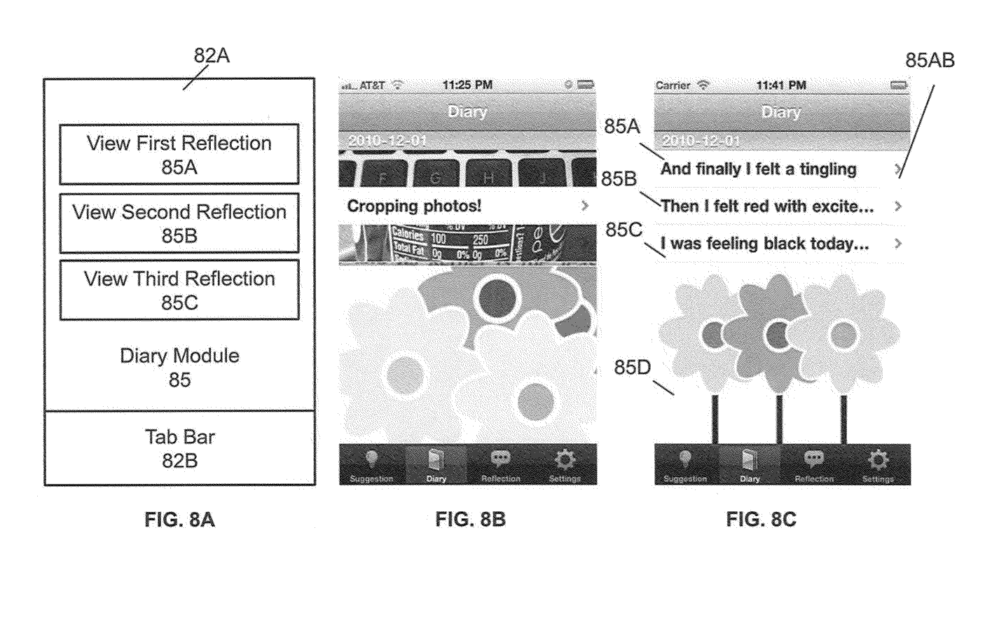

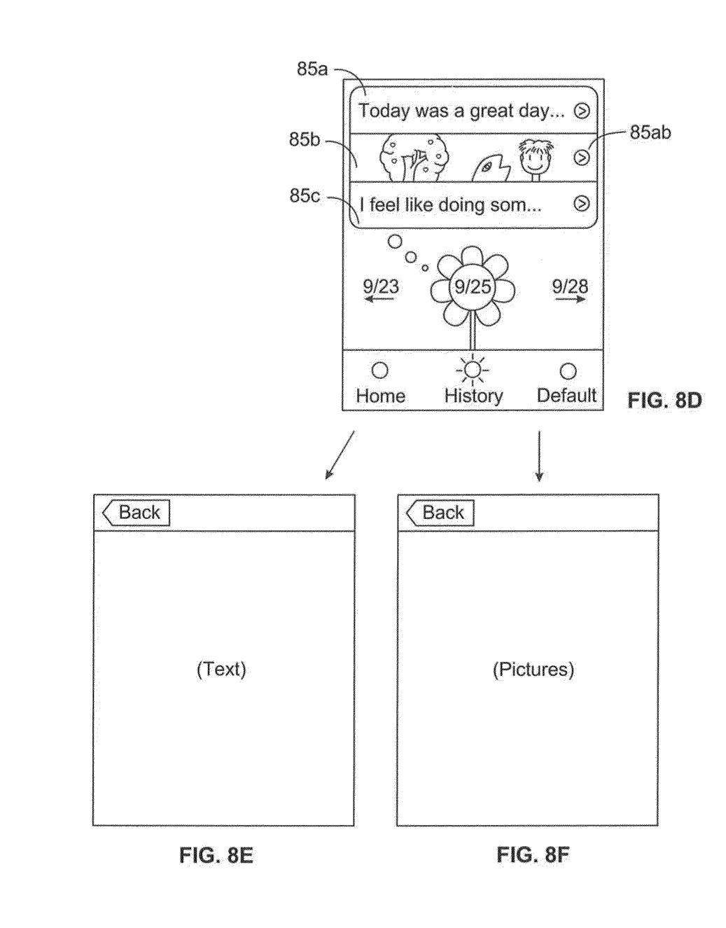

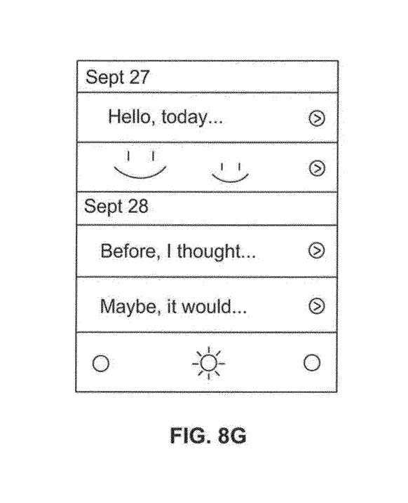

A diary module 85 may be configured to permit a user to view saved reflections, as illustrated in FIG. 8A-FIG. 8G. A diary module 85 also may include a sub-module menu 85AA including sub-modules such as a view first reflection sub-module 85A, view second reflection sub-module 85B, and view third reflection sub-modules 85C, and view visualization 85D, as illustrated in FIG. 8A, FIG. 8C, and FIG. 8D. In certain embodiments, the sub-module buttons 85AB in the sub-module menu 85AA permit the user to view a cropped portion of the reflection entry, as illustrated in FIG. 8C and FIG. 8D. Upon selecting a sub-module button 85AB, the user may view the entirety or a larger portion of the reflection entry as illustrated in FIG. 8E and FIG. 8F. In certain embodiments, the sub-module menu 85AA may be sorted by date, by type of reflection, or other selection criteria, as illustrated in FIG. 8G. Embodiments of a visualization 85D may display and permit the user to select another view of a reflection or a larger view of a visualization.

In addition, embodiments of the diary module 85 may permit creation of representations including visual representations such as charts, graphs, visualizations, audible representations such as sound emissions, physical representations, or other representations of past reflections or other user information. Such representations may permit the user to view, hear, analyze, track, and ascertain trends in mood, schedule, stress, health information, and other user information.

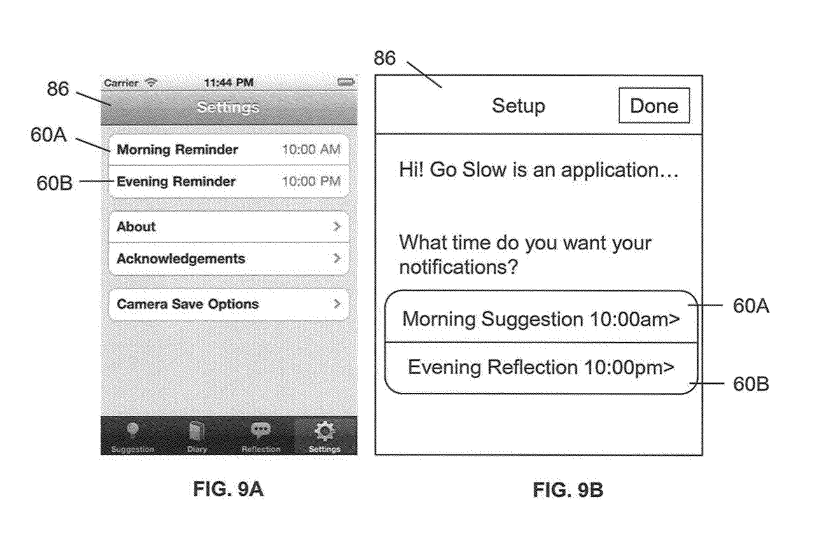

Certain embodiments of a settings module 86 may include a filtering component 60 through which the user may set up the time, content, and method of BMC, as illustrated in FIG. 9A and FIG. 9B. In certain embodiments, a first filtering component 60A is set up to permit delivery of a first BMC, and a second filtering component 60B is set up to permit delivery of a second BMC. In certain embodiments, a first BMC includes a new suggestion about what to think about for the day. For example, the application might present the user with information about the importance of breathing or sleeping. In such embodiments, a second

BMC may include a suggestion to encourage the user to reflect on his or her day and create a reflection.

A settings module 86 also may include an internal user-specific information component 90B and other information about the system 10.

Certain embodiments of the system 10 include a messaging component 100. In such embodiments, the messaging component 100 permits the user to send and receive messages through the user interface component 80. In other embodiments, the messaging component 100 permits the sending of messages to a third party designated by the user. That third party may include, for example, a healthcare provider, caregiver, or family member, who may wish to be updated on the person's state of mind or wellbeing.

In certain embodiments, the output component 70 includes a touchscreen 70B. In such embodiments, the user may navigate through the modules 82 and the pages of the modules 82 by touching a finger or a stylus to the screen to select an item. The finger or style also may swipe up or down and left and right to move through modules 82 or pages of the modules 82.

Certain embodiments of the present invention include a user log 110 configured to track the user's use of the system 10 such as receipt of BMC, creation of reflections, view of diary entries, and other system uses. Such a user log may provide information to the user, or another person such as a family member, healthcare provider, or a caregiver.

Certain embodiments include a server 120 configured to permit storage of BMC, user reflections, diary entries, user settings, user system usage patterns, and other information. In certain embodiments, the user information is accessible only to the user, or is accessible to the user and a system administrator. Certain embodiments minimize the personal user information stored on the server 120 to minimize privacy concerns. Certain embodiments of the system 10 include an internal server 120A, as illustrated in FIG. 10A. In other embodiments, the system 10 is configured to communicate over a network 11 such as the Internet, an intranet, or other network with an external server 120B such as a secure remote server, as illustrated in FIG. 10B. A single server 120 may store information from one or more users. A schematic of an exemplary server 120 is illustrated in FIG. 10C. User information may be arranged and stored in classes, as illustrated in a diagram of FIG. 10D.

A server 120 may categorize information received from different components of the system 10 by identifying each system 10 by a label such as a user ID and associating that label with the source of the incoming information. A source of information such as a computer system may be recognized by a unique device identifier (“UDID”), which may include a string of characters that uniquely identifies a device on which the system is operating. In certain embodiments, each device has a different UDID. Accordingly, the server may store a User ID and a UDID for each source of information. In certain embodiments, the server 120 will identify the device UDID and assign the User ID the first time that the server 120 receives information from that source.

In certain embodiments, the server 120 uses REST (representational state transfer) to interact with a standardized way with the other system components. The user information stored in the user interface component 80 synchronizes automatically with the server 120 after the user has exited from that component. If there is no data connection, the user information may be stored are stored in an internal memory component (or a queue) and then synchronized at a later time. User information may be identified using a timestamp and may be associated with a user ID stored in a database on the server 120. The user log information 110 also may be sent to the server 120. Embodiments of a server 120 may also store information such as instructions for communicating with a user interface component 80 or other component of the system 10.

Certain embodiments of the user information such as reflections may be stored in the following formats. Photo reflections, text reflections and color reflections each may have fields of information, including: ID that uniquely identifies the reflection and a User ID that permits association of the reflection with a user. A photo reflection may include a name of the entry, content type (JPEG, PNG, etc.), and data of the image file, which may have a maximum size such as one megabyte or 5 megabytes. A text reflection may include a name of the entry and text entered by the user. A color reflection may include a name of the entry, red components, green components, and blue components

Certain embodiments of the system 10 may be configured with a web development framework such as Ruby on Rails using a programming language such as Ruby programming language. Other embodiments are configured with other web development frameworks and programming languages.

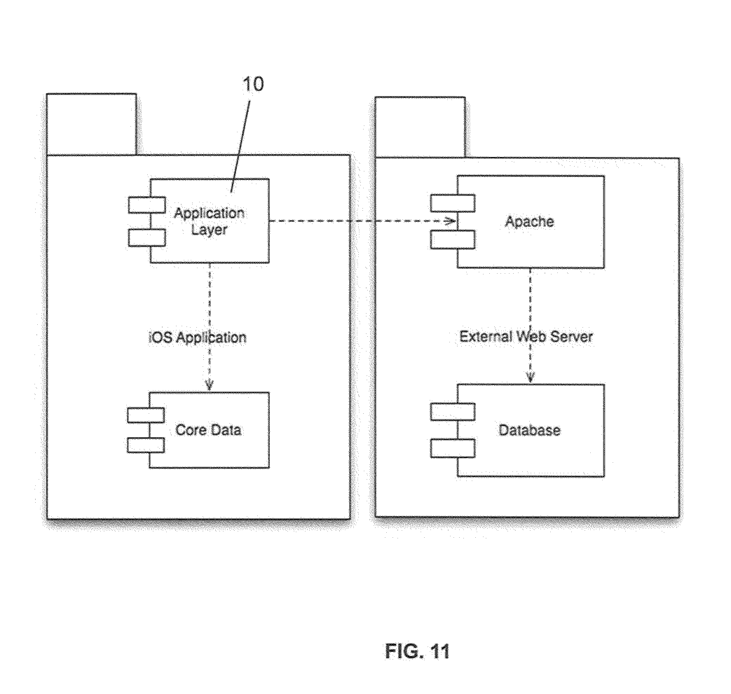

Certain embodiments of the system 10 are configured to operate in an Apple operating system, a Windows operating system, or other computer operating system known in the art. FIG. 11 illustrates an embodiment of the system 10 configured with an Apple operating system.

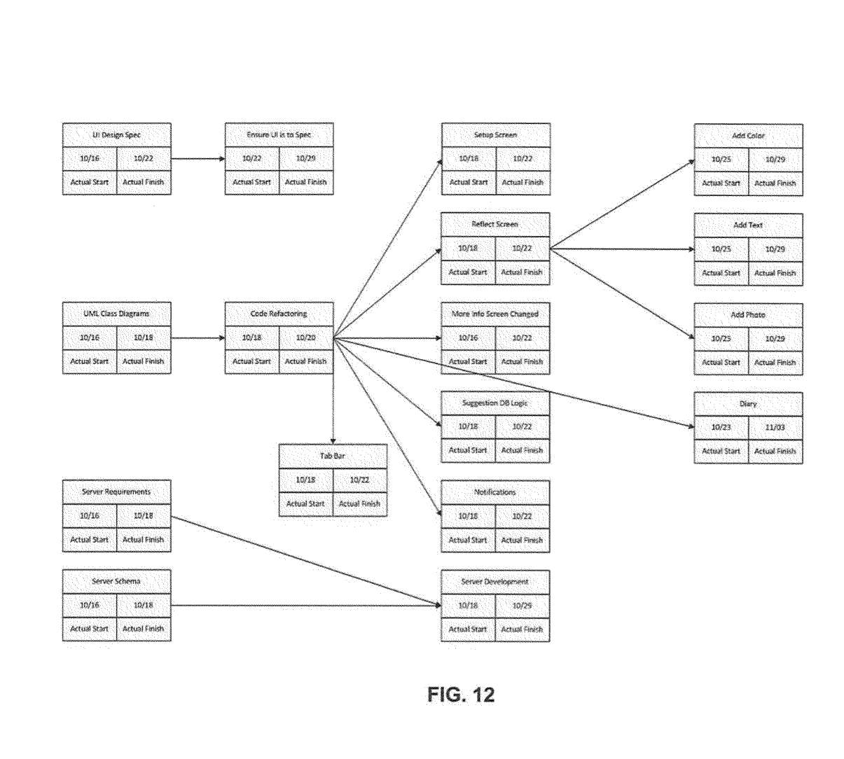

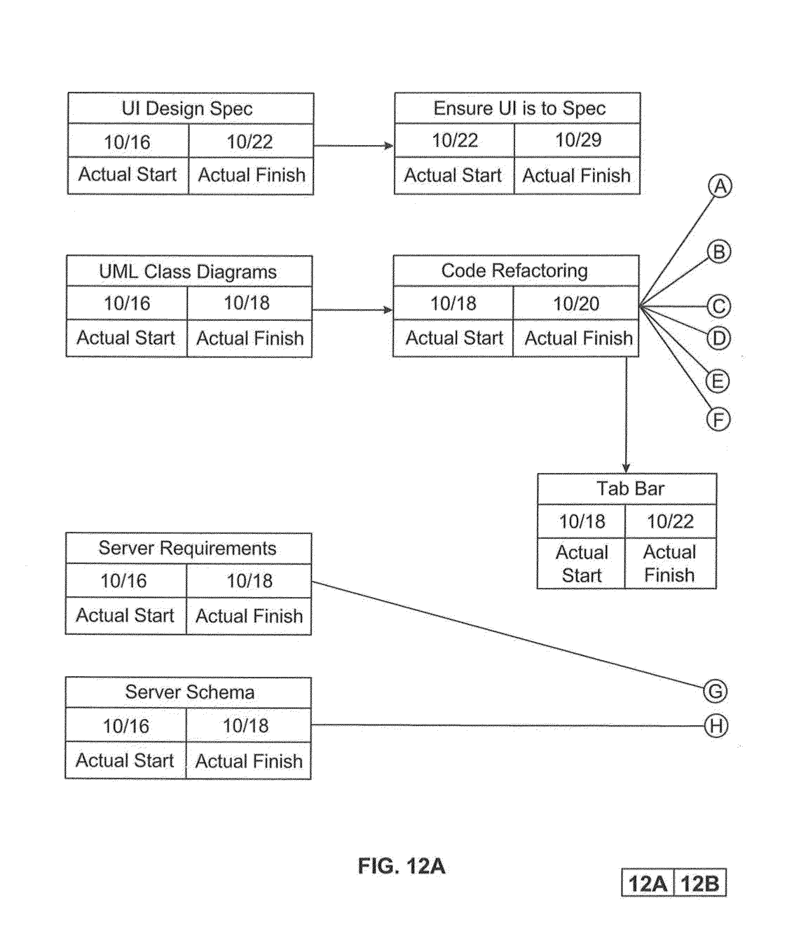

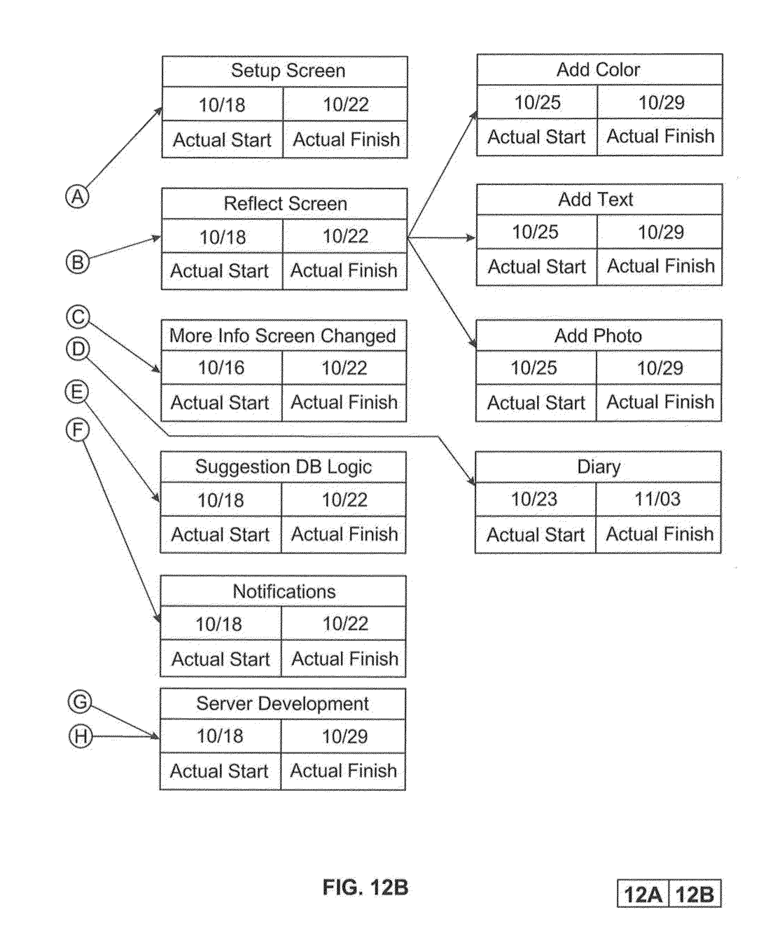

The system 10 also may implement steps according to certain dependency steps. FIG. 12 illustrates a diagram of a dependency chart of certain embodiments of the present invention.

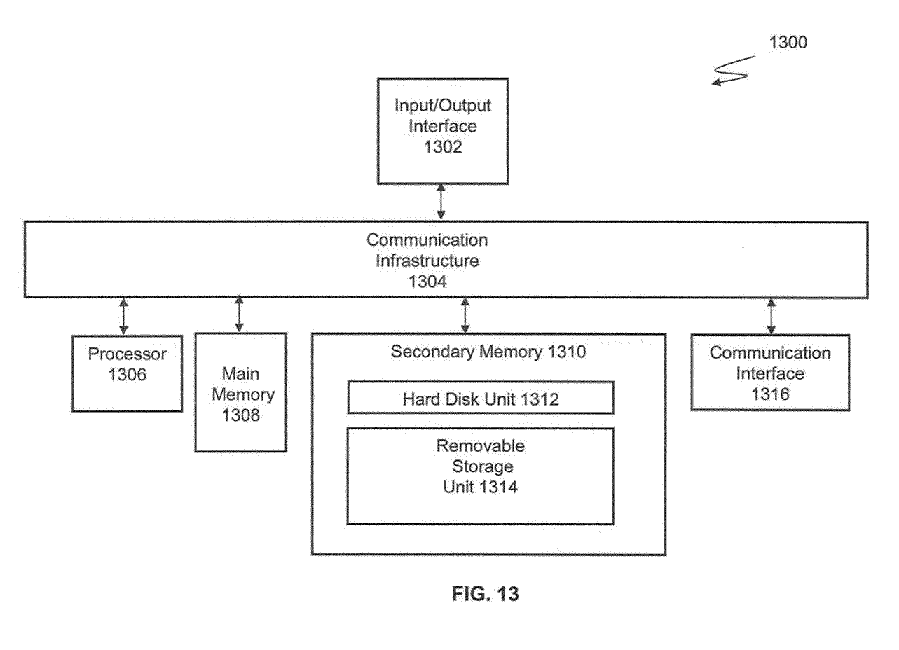

FIG. 13 illustrates an exemplary computer system 1300 that may be used in conjunction with the system 10 of the present invention or to implement certain methods according to the present invention. One or more computer systems 1300 may carry out the methods presented herein as computer code.

A computer system 1300 may include an input/output interface 1302 connected to communication infrastructure 1304—such as a bus—, which forwards data such as graphics, text, and information, from the communication infrastructure 1304 or from a frame buffer (not shown) to other components of the computer system 1300. The input/output interface 1302 may be, for example, a keyboard, touch screen, joystick, trackball, mouse, monitor, speaker, printer, scanner, any other computer peripheral device, or any combination thereof, capable of inputting data.

A computer system 1300 may include one or more processors 1306, which may be a special purpose or a general-purpose digital signal processor that processes certain information. In certain embodiments, a processor 1306 is configured to implement the selection criteria for delivery of BMC at certain times, randomly, or in response to certain contextual triggers.

A computer system 1300 also may include a memory component 50, as described above, such as a main memory 1308, for example random access memory (“RAM”), read-only memory (“ROM”), mass storage device, or any combination thereof. The memory component 20A of a computer system 1300 may also include a secondary memory 1310 such as a hard disk unit 1312, a removable storage unit 1314, or any combination thereof.

A computer system 1300 also may include a communication interface 116, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, or other interface that permits communication with other computer systems.

It is contemplated that the main memory 1308, secondary memory 1310, communication interface 116, or a combination thereof, function as a computer usable storage medium, otherwise referred to as a computer readable storage medium, to store and/or access computer software including computer instructions. For example, computer programs or other instructions may be loaded into the computer system 1300 such as through a removable storage device, for example, a floppy disk, ZIP disks, magnetic tape, portable flash drive, optical disk such as a CD or DVD or Blu-ray, Micro-Electro-Mechanical Systems (“MEMS”), nanotechnological apparatus. Specifically, computer software including computer instructions may be transferred from the removable storage unit 114 or hard disc unit 1312 to the secondary memory 1310 or through the communication infrastructure 1304 to the main memory 1308 of the computer system 1300.

Communication interface 1316 allows software, instructions and data to be transferred between the computer system 1300 and external devices or external networks. Software, instructions, and/or data transferred by the communication interface 116 are typically in the form of signals that may be electronic, electromagnetic, optical or other signals capable of being sent and received by . the communication interface 116. Signals may be sent and received using wire or cable, fiber optics, a phone line, a cellular phone link, a Radio Frequency (“RF”) link, wireless link, or other communication channels.

Computer programs, when executed, enable the computer system 1300, particularly the processor 1306, to implement the methods of the invention according to computer software including instructions.

The computer system 1300 described herein may perform any one of, or any combination of, the steps of any of the methods presented herein. It is also contemplated that the methods according to the invention may be performed automatically, or may be invoked by some form of manual intervention.

The computer system 1300 of FIG. 13 is provided only for purposes of illustration, such that the invention is not limited to this specific embodiment. It is appreciated that a person skilled in the relevant art knows how to program and implement the invention using any computer system.

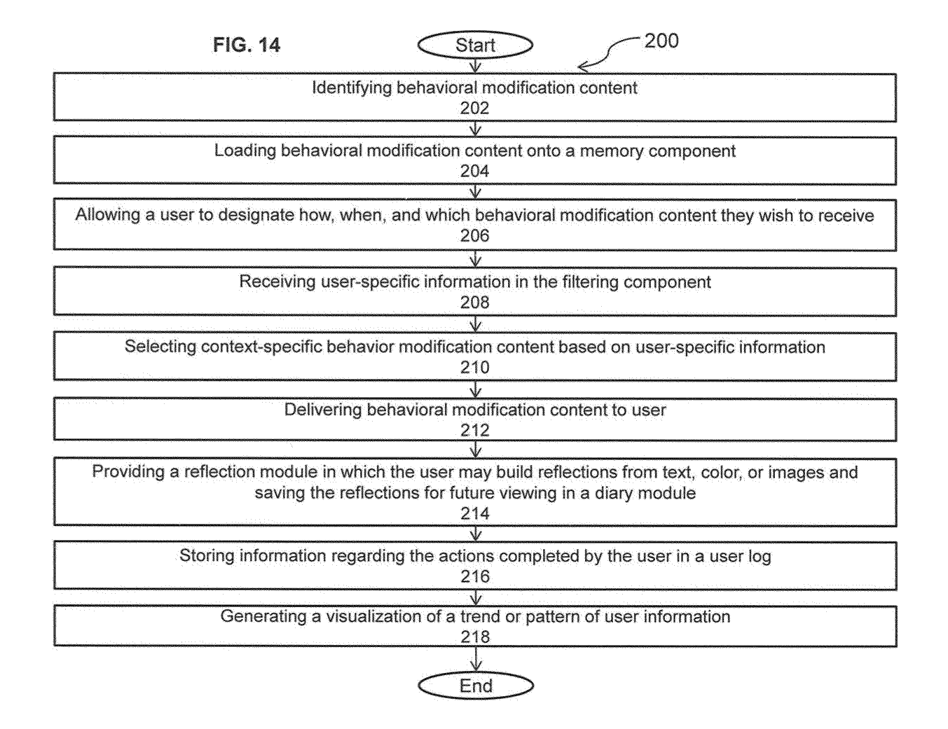

Certain embodiments of the present invention are implemented by method steps 200, as illustrated in FIG. 14. A step may include identifying or creating BMC for a user 202 and loading BMC onto a memory component 204. Another step may include allowing the user to designate how, when, and which BMC they wish to receive through a filtering component 206. In certain embodiments, a user does not choose which BMC they wish to receive, and the BMC is a surprise. Certain embodiments include the steps of receiving user-specific information in the filtering component 208 and selecting context-specific behavior .modification content based on the user-specific information received in the filtering component 210. In another step, the behavioral modification content is delivered to the user through the output component or a peripheral BMC delivery device 212. In certain embodiments, the steps include providing a reflection module in which the user may build reflections from at least one of text, color, or images and saving the reflections for future viewing in a diary module 214. Additional steps may include storing information regarding the actions completed by the user in a user log 216, or generating a representation of a trend or pattern of user information such as reflections, user log, or other information 218.

While the disclosure is susceptible to various modifications and alternative forms, specific exemplary embodiments of the present invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A system for monitoring and adjusting behavioral patterns of a user, comprising:
a memory component configured to store at least behavioral modification content, wherein behavioral modification content includes information that can be perceived by the user, including received visually, aurally, tangibly, or aromatically by the user for a purpose of improving health of the user, causing the user to temporarily remove himself or herself from the context in which the user is operating, have the opportunity to better understand that context, and reflect on that context;
a filtering component configured to permit the user to designate when, how, and which behavioral modification content is delivered to the user;
a user interface component configured to permit the user to receive information and add information to the system; and
an output component configured to permit the user to interact with the user interface component.

2. The system of claim 1 in which said filtering component includes a time filter, a content filter, and a method of delivery filter.

3. The system of claim 2 in which said content filter includes at least one of a random BMC content filter, a context-specific BMC content filter, or both a random BMC content filter and a context-specific BMC content filter.

4. The system of claim 2 in which said filtering component is configured to receive information about the user from an external user-specific information component.

5. The system of claim 1 in which said user interface component includes a suggestion module, a reflection module, a diary module, and a settings module.

6. The system of claim 5 in which said reflection module includes at least one sub-module from an add color sub-module, an add text sub-module, and an add-photo sub-module.

7. The system of claim 5 in which said diary module includes at least one sub-module from a view reflection sub-module and a view image sub-module.

8. The system of claim 5 in which said diary module includes a representation of user information.

9. The system of claim 5 in which said settings module includes an internal user-specific information component configured to permit the user to enter information about the user's context.

10. The system of claim 5 in which said user interface component further includes a module viewer and a tab bar having navigation elements.

11. The system of claim 1, further comprising a messaging component configured to permit the user to send and receive messages.

12. The system of claim 1, further comprising an external memory accessing component configured to send and receive information from an external memory component.

13. The system of claim 1, further comprising a server configured to permit storage of user information including BMC, user reflections, diary entries, user settings, usage patterns, and other information.

14. The system of claim 1, further comprising a peripheral behavioral modification content delivery device configured to permit delivery of behavioral modification content to a user.

15. A method of monitoring and adjusting behavioral patterns of a user, comprising the steps:
identifying behavioral modification content including at least some information that can be perceived by the user, including perceived visually, aurally, tangibly, or aromatically by the user for a purpose of improving health of the user, causing the user to temporarily remove himself or herself from the context in which the user is operating, better understand that context, and reflect on that context;
loading behavioral modification content to a memory component that is configured to store behavioral modification content;
allowing the user to designate how, when, and which behavioral modification content should be delivered to the user through a filtering component; and
delivering behavioral modification content to the user.

16. The method of claim 15, further comprising the steps of:
providing a reflection module in which the user may build reflections from at least one of text, color, or images; and
saving the reflections for future viewing in a diary module.

17. The method of claim 15, further comprising the steps of:
receiving of user-specific information in the filtering component; and
selecting context-specific behavior modification content for delivery based on the user-specific information received in the filtering component.

18. The method of claim 15, further comprising the steps of:
using random selection to choose behavior modification content for delivery to the user.

19. The method of claim 15, further comprising the step of:
storing information regarding the actions completed by the user in a user log.

20. The method of claim 15, further comprising the step of:
generating a representation of user information such as reflections, user log information, or other information.
